(19) United States
(12) Patent Application Publication
(10) Pub. No.: US 2013/0265314 A1
(43) Pub. Date: Oct. 10, 2013

(54) METHOD AND APPARATUS FOR CAPTURING AND ANALYZING REAL-TIME USER SENTIMENT FOR AN EVENT

(71) Applicant: BUZZERANDBELL, INC., Boston, MA (US)

(72) Inventor: Matthew J. Laughlin, Boulder, CO (US)

(73) Assignee: BUZZERANDBELL, INC., Boston, MA (US)

(21) Appl. No.: 13/859,296

(22) Filed: Apr. 9, 2013

Related U.S. Application Data
(60) Provisional application No. 61/621,606, filed on Apr. 9, 2012.

(51) Int. Cl. G06T 11/20

(52) U.S. Cl. CPC G06T 11/206
USPC 345/440

(57) ABSTRACT

Methods and structure are provided for collection and analysis of real-time reactions of a large audience during an event. For example, one method includes collecting responses to an event from a plurality of user devices and linking a timestamp associated with each individual response to a corresponding point of time in the event. Each individual response indicates either a positive user response or a negative user response. The method also includes compiling a subset of the responses having one or more demographic factors in common and displaying a graph of the subset as a function of time with respect to the event.

### CROSS REFERENCE TO RELATED APPLICATIONS

This patent application claims priority to, and thus the benefit of an earlier filing date from, U.S. Provisional Patent Application No. 61/621,606 (filed Apr. 9, 2012), the entire contents of which are hereby incorporated by reference.

### FIELD OF THE INVENTION

The invention relates generally to the field of interactive media, and more specifically to collecting user reactions to an event in real-time.

### BACKGROUND

Dial testing provides a way to measure and collect information about how an individual perceives an event as it unfolds in front of them. This collected information can prove very valuable to marketers, researchers, and media companies as they continually look for ways to evaluate and improve the overall engagement of a target audience. Traditional dial testing uses hand-held dials that can be turned to register positive and negative reactions in real time. A live moderator is typically present to keep the audience engaged so that meaningful information is logged as the event is played in the room. However, current dial testing methods are not practical for collecting and cataloging accurate information across large audiences, particularly those engaged in network television events.

### SUMMARY

Systems and methods herein provide for collection and analysis of real-time reactions of an audience during an event. The reaction information as a whole is parsed into more meaningful units of information by segmenting the audience into demographics and/or by segmenting the content into critical time points of heavy audience reaction. Reaction data is synchronized in time with the observed event to enable content tagging, searching, and display of critical elements associated with the reaction information.

In one particular embodiment, a method includes collecting responses to an event from a plurality of user devices and linking a timestamp associated with each individual response to a corresponding point of time in the event. Each individual response indicates either a positive user response or a negative user response to a point in time during the event. The method also includes compiling a subset of the responses having one or more demographic factors in common and displaying a graph of the subset as a function of time with respect to the event.

Other exemplary embodiments (e.g., systems and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary system architecture for the collection and analysis of real-time reactions of an audience during an event.

FIG. 2 is a flowchart describing an exemplary process according to the system architecture of FIG. 1.

FIG. 3 is an exemplary screenshot operable with the system architecture of FIG. 1.

FIG. 4 is a flowchart describing another exemplary process according to the system architecture of FIG. 1.

FIG. 5 is a block diagram of exemplary summarization tables.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

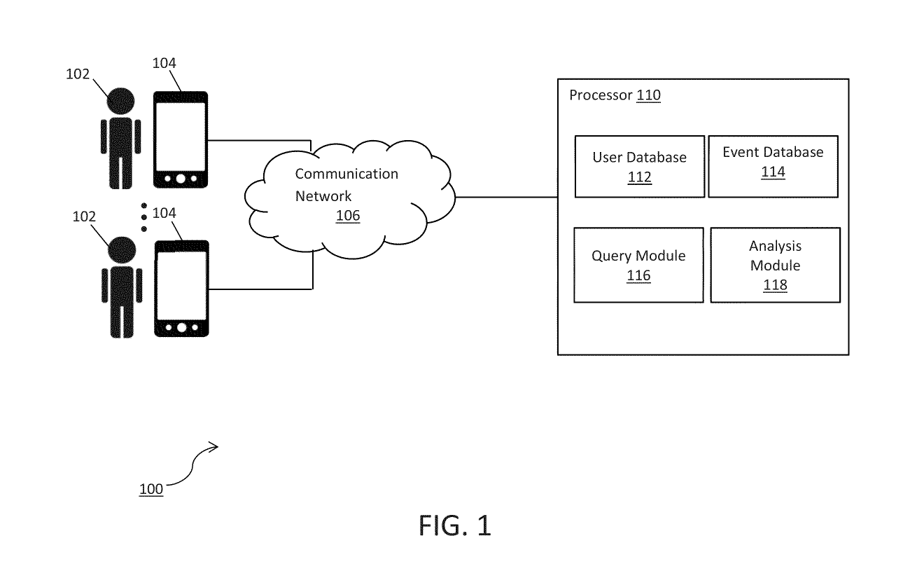

FIG. 1 is a block diagram of an exemplary system architecture 100 for the collection and analysis of real-time reactions of an audience during an even. The system architecture 100 includes a client-side portion and a server-side portion. The client-side portion is made up of one or more user devices 104 each having an application running thereon. The application communicates with the server-side portion of the system architecture 100. The server-side portion of the system architecture 100 is configured to collect information from each of the user devices 104 and provide further analysis regarding the real-time user reactions in response to the event.

The user 102, while observing an event provides real time feedback on the sequence of the event via the user device 104. User devices 104 include, but are not limited to, smartphones, cell phones, personal computers, laptops, personal media devices, tablets, and smart televisions. In one exemplary embodiment, the user device 104 has a processor subsystem such as a digital signal processor, microprocessor, field-programmable gate array, or plurality of processing components mounted on one or more substrates. The processing subsystem may also comprise an internal cache memory. The processing subsystem is connected to a memory subsystem comprising memory which may for example, comprise SRAM, flash, and SDRAM components. The memory subsystem contains computer-executable instructions which are executable by the processor subsystem.

The client application is operable with the user device 104 as software that interacts with the processor 110 on the server-side portion of the system architecture 100. For example, the client application may employ a graphical user interface such that the user may interact with the client application and thus with the server-side portion of the system architecture 100.

The user device 104 can comprise of one or more wireless interfaces adapted to connect to one or more wireless networks (e.g., the communication network 106). The multiple wireless interfaces may support different radio technologies such as GSM, CDMA, UMTS, LTE/LTE-A, WiMAX, WLAN, Bluetooth, etc. by implementing the appropriate antenna and modem subsystems.

The event as used herein refers to any subject of review, happening, occurrence, performance, or any other activity for which a user can provide feedback. The event generally has a start and end time and may be broken down into intervals, parts, sections or divisions between the beginning and end of the event.

On the server-side portion of the system architecture 100 is a processor 110 that is operable to interact with the user devices 104 via the mediation network 106 and process the responses therefrom. The processor 110 includes a user database 112 for storing user data, and an event database 114 for storing and maintaining event details. The processor 110 also includes an analysis module 118 for processing the user data, the comments data and the event details received from the user devices 104. The processor 110 may also include a content inquiry or query module 116 that is operable to present questionnaires or surveys to the users 102 during the event. For example, when a user provides a response during a particular event, the analysis module 118 may analyze the response and direct the query module 116 to elicit additional information from the user during the event.

The processor 110 may be a server, computer, or series of computers, that link other computers or electronic devices together and is dedicated to running one or more specific services such as processing, data storage and management, email services, web services, etc. serving the needs of programs running on other computers on the network 106.

Real time feedback being transmitted to the processor 110 from the user devices 104 is synced and stored in the processor 110. This feedback is then correlated to the event to produce a comprehensive and dynamic review of the event.

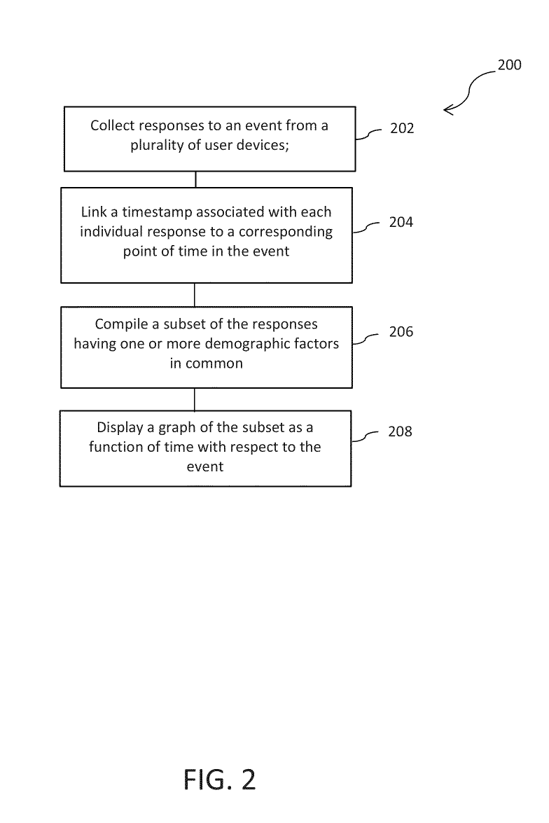

FIG. 2 is a flowchart 200 of a process operable within the system architecture 100 of FIG. 1. Generally, the flowchart 200 initiates from the server-side portion of the system architecture 100 when responses from the user devices 104 are received. Thus, in the process element 202, the processor 110 collects responses to an event from a plurality user devices 104. As the responses from the user devices 104 are received, the processor 110 links a timestamp associated with each response to a corresponding point of time in the event, in the process element 204. For example, as a user 102 transmits positive or negative responses to an event through the user device 104, the processor 110 associates each of those responses to a point in time during the event to correspond the responses with the event.

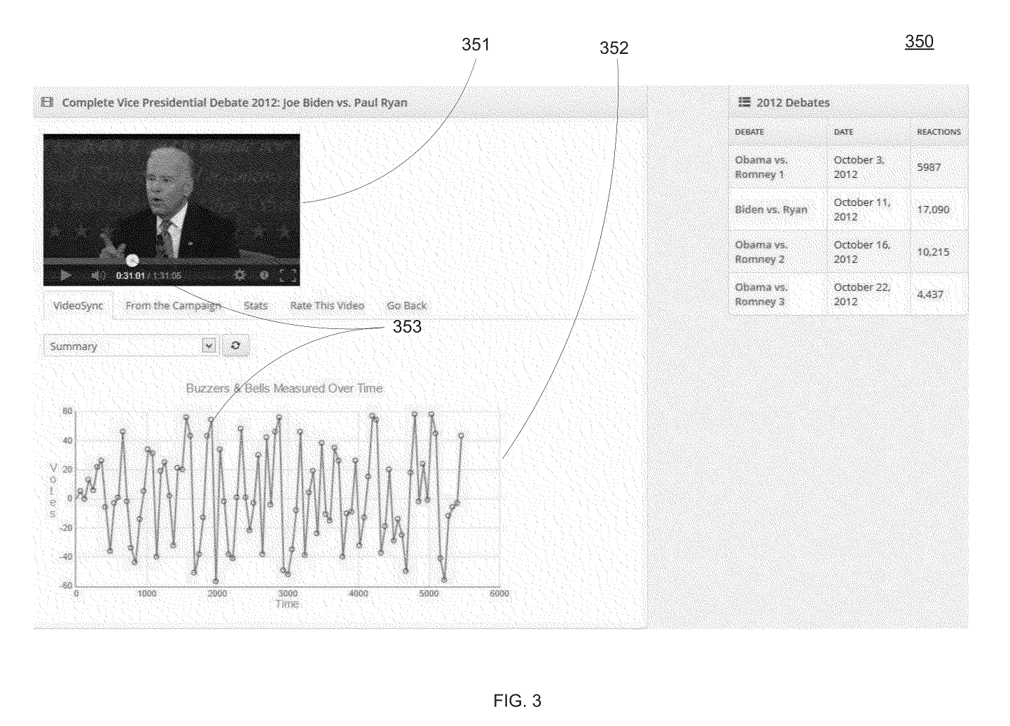

In the process element 206, the processor 110 compiles a subset of the responses according to one of more demographic factors. For example, the users 102 may submit information to the processor 110 that describes their particular demographics. This demographic information of the users 102 may be stored in the user database 112 such that it may be associated with the users' responses during the event. The processor 110 may group a set of responses according to a particular demographic (e.g., males between the ages of 22 and 30 living in Southern California). Once the responses have been collected and associated with the real-time event, the analysis module 118 of the processor 110 displays a graph of the subset as a function of time with respect to the event, in the process element 208. An example of such is shown in FIG. 3.

FIG. 3 is a screenshot 350 of an event and its associated graph of votes. As can be seen in this screenshot 350, the analysis module 118 is operable to display a number of positive and negative responses that are associated with a point in time with the event. In this embodiment, the event 351 is the 2012 vice presidential debate between Mr. Joe Biden and Mr. Paul Ryan. As people watch the event 351, they enter their responses through their respective user devices 104 generally as a series of either positive or negative responses. For example, if a particular user enjoys a segment of the event 351, the user through the associated application of the user device 104 may select a positive response numerous times, a sort of virtual “bell” indicating such enjoyment. If the user does not enjoy the segment of the event 351, the user selects a negative response one or more times, a sort of virtual “buzzer” indicating that dismay.

The user responses are processed and correlated to a recording of the event 351 by the analysis module 118 such that they may be selected and played back subsequent to the event 351 to illustrate the positives and negatives of the event 351 from the aspect of the users. For example, roughly 52 votes were cast at about the time segment 2000 which corresponds to the 31 minute and 1 second point of the event 351. The analysis module 118 presents this graph 352 of votes with the video clip of the event 351 such that a subsequent user may select either a point in time in the event 351 or a number of votes on the graph 352. In any case, the analysis module 118 provides the subsequent user with the ability to observe a recording of the event 351 with responses that were associated with the event 351 in real time.

As mentioned, the users 102 may provide the processor 110 with certain demographic information which is maintained by the user database 112. The analysis module 118 may be operable to access the user database 112 and provide graphs according to certain specified demographics. For example, if a subsequent user were wishing to find out the responses to the event 351 for women between the ages of 28 and 40 living in New Hampshire, the analysis module 118 may search for that demographic in the user database 112. Once retrieved, the analysis module 118 presents that response data with the recording of the event 351. In this regard, each response/vote of a user may also be associated with a search tag. The analysis module 118 may therefore be operable to process potential search tags from subsequent users to locate the demographics in the user database 112. As such, the system architecture 100 is operable to provide a real-time collection of user sentiment during an event for a robust documentation and presentation for a subsequent user.

Also seen in screenshot 350 is a selection component that categorizes the events for selection by the users 102. For example, a user wishing to view the Biden/Ryan debate mentioned above may also wish to view one of the Obama/Romney debates of the 2012 election. The events may be tag with certain identifiable features that categorize or otherwise group the events such that the users 102 may quickly locate and select potentially desirable events.

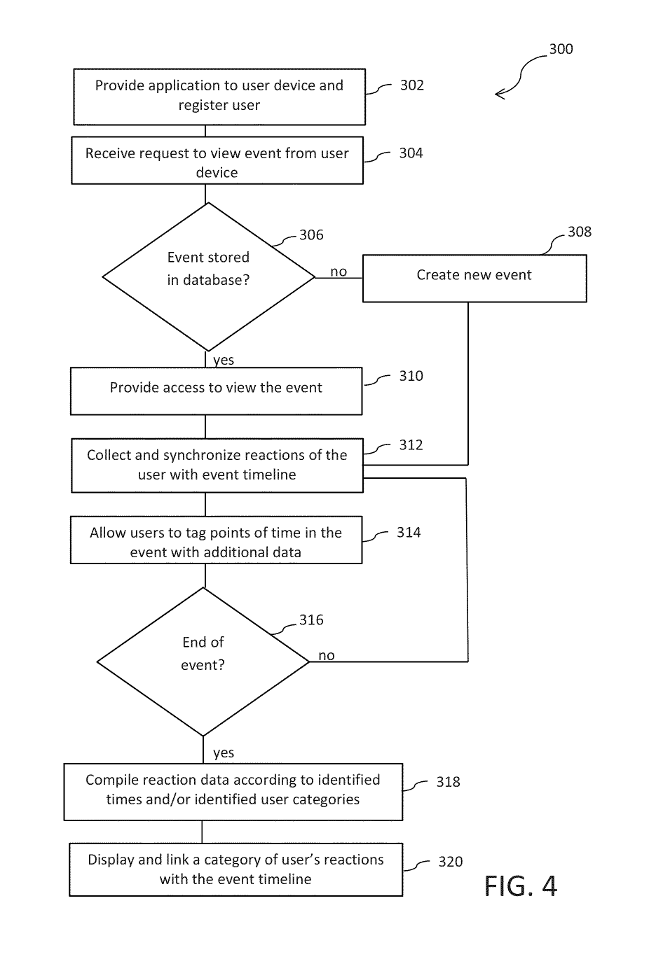

FIG. 4 is a flowchart 300 of another exemplary process operable with the system architecture 100 of FIG. 1. In this embodiment, the processor 110 initiates by providing an application to the user device 104 such that the user 102 may interact through the user device 104 with the processor 110 through the communication network 106, in the process element 302. In this regard, the application may also allow the user 102 to register with the processor 110. Thereafter, the processor 110 may receive a user request to the view an event from the user device 104, in the process element 304. For example, a user registered with the processor 110 may wish to participate in the event by providing the aforementioned positive and negative responses through the user device 104. The processor 110 then determines whether the event is stored in the event database 114, in the process element 306. If the event is stored in the database, the processor 110 provides access to the user 102 to view the event and provide responses, in the process element 310.

If the event does not exist, the processor 110 may provide the user 102 with the option of creating a new event 308. For example, a user 102 may wish to provide a live event or a recorded event to the processor 110 such that other users 102 may participate in the responses to the event. To further illustrate, suppose a user 102 wishes to provide a live recording of a band's concert to determine an interest in the band from a larger number of people. The processor 110 may create the concert event such that other users may observe the concert and provide responses.

In either case, the analysis module 118 collects and synchronizes reactions of the users with the event timeline, in the process element 312, in the manner similarly described above. In this embodiment, the processor 110 allows the users to tag points of time in the event with additional data, in the process element 314. For example, if a user 102 is providing a series of responses at a point in time in the event, that series of responses may pass some threshold which triggers the elicitation of additional input being requested by the processor 110. In other words, if the user 102 provides numerous responses, the processor 110 may provide a survey or a questionnaire to the user 102 via the application of the user device 104 to elicit more information from the user 102 about the particular point in time in the event. This additional information may be associated with that point in time of the event so as to tag the event with the additional information that may be subsequently searchable by the analysis module 118.

The processor 110 continually monitors the event to determine whether the end of the event has occurred, in the process element 316. If the event has not ended, the processor 110 continues to collect and synchronize reactions of the user with the event timeline. Otherwise, the processor 110 compiles the reaction data according to identified times and/or identified user categories (e.g., demographics), in the process element 318. Thereafter, the analysis module 118 may display and link the user reactions with the event timeline (e.g., by category), in the process element 320, as similarly described above.

In one embodiment, the analysis module 118 is further operable to combine positive and negative responses into a total net number of responses and associate that with the timeframe of the event. For example, the analysis module 118 may provide a net sum of positive and negative responses according to demographics to provide an overall view of how a particular demographic may have felt about the particular event. In another embodiment, the analysis module 118 may be further operable to identify periods in the event which were somewhat important. For example, the analysis module 118 may have a certain predetermined threshold. Once the number of responses (positive or negative) passes that threshold at a certain point in time in the event, the analysis module 118 may flag that time of the event such that subsequent users may search for the so-called important points in the event.

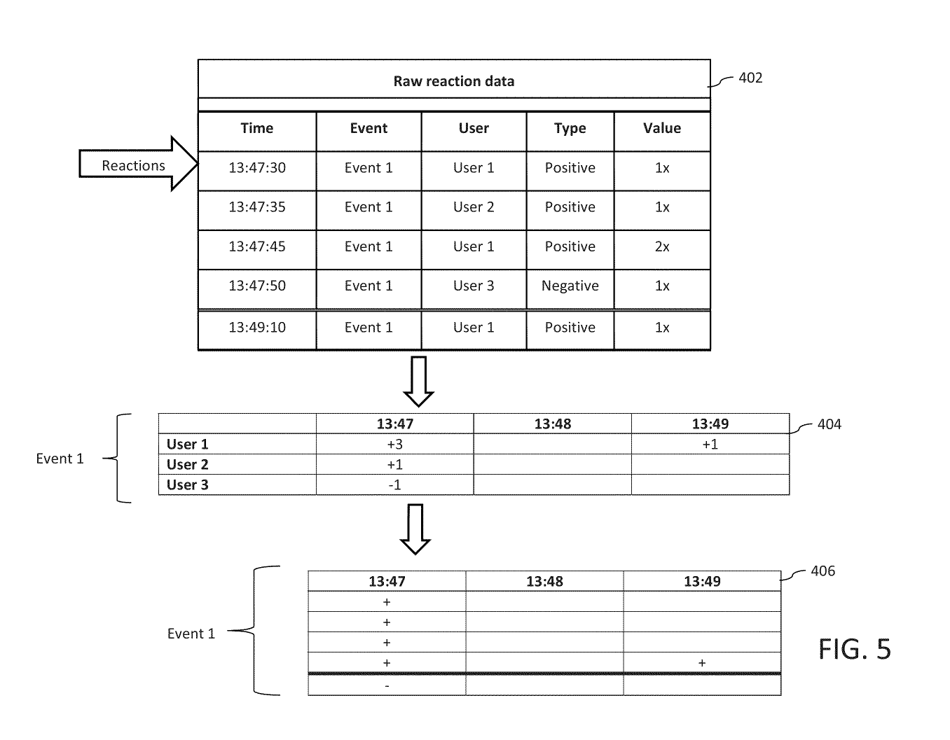

FIG. 5 is a block diagram of exemplary summarization tables 402, 404, and 406. In this embodiment, the processor 110 receives a communication from one or more user devices 104 in the format shown in the table 402. By way of example, each time a user 102 interacts with the user interface on the user device 104, the resident application on the user device 104 sends a string of information that includes a Time, Event, User, Type, and Value.

The Time entry may represent the moment that the user 102 pressed an interactive element on the graphical user interface. In another variant, the time represents the moment that the communication was received at the processor 110. The time may represent a global time, a local time, or a relative time with respect the event being watched.

Table 402 also includes a User entry and an Event entry. As discussed above, the processor 110 may receive communications from many different user devices about a number of different ongoing events. Thus, each communication received at the processor 110 can identify which user 102 is sending the communication in the User entry of the table 402 and which event the communication is about in the Event entry. Information regarding the specific user and event may be automatically embedded by the user device application into the data that is communicated to the processor 110.

Table 402 further includes which type of feedback is being communicated in the Type entry and the value of the feedback in a Value entry. For example, at time 13:47:45, User 1 sent a Positive response about Event 1. At that time, User 1 indicated a Value of 2, meaning there was an extra emphasis on the positive sentiment of User 1 at this moment in the event. The value may be adjusted by tuning or interacting with the graphical user interface on the client application. For example, User 1 may have pressed a ‘+’ button on the graphical user interface two times in rapid succession so that a value of 2 is represented near the time 13:47:45.

Table 404 shows that the received user responses can be further organized by the time and user demographic in an event summary. It may be determined that User 1, User 2, and User 3 all belong to the same demographic by referencing the user database 112. Each of Users 1-3 may, for example, be all women. Table 404 divides the event into one minute increments and shows each of the Users 1-3 responses for each elapsed minute of the event. As Table 404 shows, User 1 gave three positive responses during minute 13:47, User 2 gave one positive response during minute 13:47, and User 3 gave one negative response during minute 13:47.

Table 406 shows a visual representation of the total number of positive responses and negative responses received in a given interval of the event. As shown, in minute 13:47, four total positive responses were received and one total negative responses was received. During interval 13:48, no responses were received from any of Users 1-3. Interval 13:49 received one total positive response. In this way, Table 406 shows a visual summary of the total overall interest of a given user group and displays the interest moment-to-moment as the event unfolds.

Although shown and described with certain timing intervals, the invention is not intended to be limited to any particular unit of time. For example, the analysis module 118 may allow subsequent users to observe points in an event at the hour time interval, minute time interval, and/or the second time interval. Also it should be noted that the invention is not intended to be limited merely to live events. For example, users may submit recorded events for stored events within the event database 114. The processor 110 may provide the recorded event to other subsequent users for their observance and responses thereto. The analysis module 118 may collect the responses of the recorded event and associate those responses with the timeline of the event being played back to the subsequent users.

What is claimed is:

1. A system, comprising:
a processor operable to collect responses to an event from a plurality of user devices, and to link a timestamp associated with each individual response to a corresponding point of time in the event, wherein each individual response indicates a positive user response or a negative user response; and
an analysis module operable to compile a subset of the responses having one or more demographic factors in common, and to display a graph of the subset as a function of time with respect to the event.

2. The system of claim 1, wherein:
the event is recorded and divided into a plurality of timeframes and the graph comprises a plurality of data points, each data point indicates a total number of the positive user responses belonging to the subset and collected within a common timeframe.

3. The system of claim 2, wherein:
a second graph comprises a plurality of second data points, each second data point indicates a net total of the number of positive user responses and the number of negative user responses belonging to the subset and collected within a common timeframe.

4. The system of claim 2, wherein:
the analysis module is further operable to display the recording of the event and a corresponding timeline marker, the timeline marker simultaneously indicating a current location within the recording and a corresponding location of the graph of the subset.

5. The system of claim 2, wherein:
the analysis module is further operable to identify one or more periods of time which have a number of responses belonging to the subset that exceed a predetermined threshold.

6. The system of claim 5, further comprising:
a query module operable to prompt a user device for additional information when it is determined that the user device is watching the portion of the event that coincides with the identified one or more periods of time.

7. The system of claim 6, wherein:
the additional information comprises a searchable tag that is stored with the recording of the event and associated with a specific point of time in the recording of the event; and
the query module is further operable to search for the tag.

8. A method, comprising:
collecting responses to an event from a plurality of user devices;
linking a timestamp associated with each individual response to a corresponding point of time in the event, each individual response indicating either a positive user response or a negative user response;
compiling a subset of the responses having one or more demographic factors in common; and
displaying a graph of the subset as a function of time with respect to the event.

9. The method of claim 8, further comprising:
recording the event;
dividing the event into a plurality of timeframes; and
graphing a plurality of data points, each data point indicating a total number of the positive user responses belonging to the subset and collected within a common timeframe.

10. The method of claim 9, further comprising:
graphing a plurality of second data points, each second data point indicating a net total of the number of positive user responses and the number of negative user responses belonging to the subset and collected within a common timeframe.

11. The method of claim 9, further comprising:
displaying the recording of the event and a corresponding timeline marker, the timeline marker simultaneously indicating a current location within the recording and a corresponding location of the graph of the subset.

12. The method of claim 9, further comprising:
identifying one or more periods of time which have a number of responses belonging to the subset that exceed a predetermined threshold.

13. The method of claim 12, further comprising:
prompting a user device for additional information when it is determined that the user device is watching the portion of the event that coincides with the identified one or more periods of time.

14. The method of claim 13, further comprising:
embedding the additional information as a searchable tag that is stored with the recording of the event and associated with a specific point of time in the recording of the event; and
searching for the tag.

15. A non-transitory computer readable medium embodying programmed instructions which, when executed by a processor, are operable direct the processor to:
collect responses to an event from a plurality of user devices;
link a timestamp associated with each individual response to a corresponding point of time in the event, each individual response indicating either a positive user response or a negative user response;
compile a subset of the responses having one or more demographic factors in common; and
display a graph of the subset as a function of time with respect to the event.

16. The computer readable medium of claim 15 further comprising instructions that direct the processor to:
record the event;
divide the event into a plurality of timeframes; and
graph a plurality of data points, each data point indicating a total number of the positive user responses belonging to the subset and collected within a common timeframe.

17. The computer readable medium of claim 16, further comprising instructions that direct the processor to:
graph a plurality of second data points, each second data point indicating a net total of the number of positive user responses and the number of negative user responses belonging to the subset and collected within a common timeframe.

18. The computer readable medium of claim 16, further comprising instructions that direct the processor to:
display the recording of the event and a corresponding timeline marker, the timeline marker simultaneously indicating a current location within the recording and a corresponding location of the graph of the subset.

19. The computer readable medium of claim 16, further comprising instructions that direct the processor to:
identify one or more periods of time which have a number of responses belonging to the subset that exceed a predetermined threshold.

20. The computer readable medium of claim 19, further comprising instructions that direct the processor to:
prompt a user device for additional information when it is determined that the user device is watching the portion of the event that coincides with the identified one or more periods of time.
